(19) United States
(12) Patent Application Publication
(10) Pub. No.: US 2025/0347987 A1
(43) Pub. Date: Nov. 13, 2025

(54) Projection Screen Maintaining Polarization State of Projection Light

(71) Applicants: SHENZHEN PHOTONIC CRYSTAL TECHNOLOGY CO., LTD., Shenzhen (CN); SHENZHEN TIME WAYING TECHNOLOGY CO., LTD., Shenzhen (CN)

(72) Inventors: Yongjing WANG, Shenzhen (CN); Gang ZHENG, Shenzhen (CN); Xiyu ZHANG, Shenzhen (CN); Wingyip Kenny CHOW, Shenzhen (CN)

(73) Assignees: SHENZHEN PHOTONIC CRYSTAL TECHNOLOGY CO., LTD., Shenzhen (CN); SHENZHEN TIME WAYING TECHNOLOGY CO., LTD., Shenzhen (CN)

(21) Appl. No.: 18/011,839

(22) PCT Filed: Jun. 23, 2021
(86) PCT No.: PCT/CN2021/101842

§ 371 Date: May 12, 2023

(30) Foreign Application Priority Data
Jun. 24, 2020 (CN) 202010587632.8
Jun. 24, 2020 (CN) 202021209380.7

(51) Int. Cl. G03B 21/604; G02B 5/30; G02B 30/25

(52) U.S. Cl. CPC G03B 21/604; G02B 5/3058; G02B 30/25

(57) ABSTRACT

The present invention discloses a projection screen capable of maintaining a polarization state of projection light redirected to the viewers. It comprises a plurality of optical projection screen units that further comprises at least two layers of optical layered structures, wherein the phase change of the light passing through each optical layered structure is compensated by other layers. The material of each layer of said optical layered structure are optical medium film and/or metal film. In the present invention, the material and thickness of said two optical layered are desinged to to have substantially phase compensation, i.e. the phase shifting of the light caused by one optical layer are compensated by the another layer(s) of said optical layered structure, thus the polarization state of emergent light is consistent with the polarization state of incident light. The polarization maintaining ratio may be 200:1 to 2000:1 or more. A typical polarization maintaining ratio is 1000:1. The said projection screen can be used in 3D movie theater to reduced the ghosting image of 3D movies caused by polarization decay. The viwers have less dizziness. The 3D movie viewing experience is improved.

### TECHNICAL FIELD

The present invention relates to the field of 3D display technology, in particular to a projection screen maintaining a polarization state of projection light.

### BACKGROUND

3D cinemas provide people with a viewing experience closer to reality, and has become a mainstream of cinemas in recent years. A 3D cinema is typically implemented by using one or two projectors plus a polarizer or polarization conversion device to project pictures to be viewed by the left eye and the right eye respectively. The polarization states of the pictures for the left eye and the right eye are different. A screen scatters and reflects light from the projector. A viewer wears polarized glasses to distinguish the images for the left eye and the right eye, so that the left eye only sees the left eye image, and the right eye only sees the right eye image. The human brain constantly processes the images for the left and right eyes to produce a stereoscopic effect and generate 3D image.

A 3D projection screen is typically a metal screen formed by coating a substrate with a metal reflective layer. The applied material typically are in the form of metal powder or many tiny metal sheets, which has a certain orientation angular distribution, therefore the screen redirect the incident light to a certain range of viewing angle. The viewers can see the image at different angles. The polarization state of the reflected light is preserved because of the reflection of tiny metal sheets. However, there always are some depolarization effect when light is reflected on any interface. The depolarization effect mainly originates from several completely different physical mechanisms, as shown in FIG. 1 to FIG. 3 specifically.

The first mechanism is phase depolarization. When light is reflected on any medium interface, a phase is introduced thereto regardless of the type of the material, transparent optical medium or metal material. The phase of the p-linearly polarized light and the phase of the of s-linearly polarized light are added with different phase changes Δ, as shown in FIG. 1A and FIG. 1B. Please note that the phase change Δ is a constant π when the refection angle is less than a certain angle for the reflection on an optical multilayer medium film. When the reflection is on a metal interface, the phase change Δ is a variable. This variable phase change leads to a change in the polarization state of the incident linearly polarized light, which means that depolarization of the light occurs.

The second depolarization mechanism is reflection amplitude depolarization. When a light beam I is reflected on any surface, the reflectivity for p-linearly polarized light and the reflectivity for s-linearly polarized light on the surface are different except the normal incident light. After the p-linearly polarized light and the s-linearly polarized light are reflected, the reflected light O becomes P′ and S′, as shown in FIG. 2.

Although there is no phase change in the phase of the reflected light, the amplitudes of the p-linearly polarized light and the s-linearly polarized light changed after reflection. P′ and S′ are eventually combined into reflected light with a changed polarization state, which means that depolarization occurs.

The third depolarization mechanism is geometric depolarization. When a light beam is reflected, even the polarization state of the light does not change with respect to a linear coordinate system, its space vector polarization actually changes in the absolute coordinate system. The polarization state of reflected light is changed after the light is reflected for multiple times. FIG. 3 shows an extreme case, where the polarization state of reflected is rotated by 90 degrees after the light is reflected for three times even every reflection is an ideal reflection without any additional phase change or amplitude change.

Currently, 3D projection screens have a certain depolarization effect on reflected light, especially in the case of large viewing angles. An image projected for the left eye by a projector has a specific polarization direction, for example left-handed light. When the image is projected to a 3D projection screen, the majority of the reflected light is right-handed circularly polarized light while a small part of the reflected light becomes left-handed circularly polarized light due to depolarization. This causes a change in the polarization state of the projection light on the screenuch that the right eye not only sees an image for the right eye, but also sees a small part of an image for the left eye. This effect causesa ghosting image on the screen. The viewers are liable to feel dizzy and the viewing experience of the 3D cinema is greatly worsened. At present, a typical 3D projection screen has a polarization maintaining ratio of only 100:1, which means that 1% of polarized light of the left eye image changes to another polarization state in a ghost iamge. The viwer experience is not good. There are a few types of high-end screens where the polarization maintaining ratio is close to 800:1 but they are very expensive. There is an urgent need in the market for a 3D projection screen capable of maintaining a polarization state of projection light without ghosting.

Therefore, the prior art has shortcomings and needs to be improved.

### SUMMARY

An objective of the present invention is to overcome the shortcomings of the prior art, and provide a projection screen capable of maintaining a polarization state of projection light. The polarization maintaining ratio can reach 200:1 to 2000:1 or more. Ghosting of 3D movies is greatly reduced Thus dizziness can be reduced and 3D movie viewing experience can be improved.

To achieve the above objective, the present invention is implemented by the following technical solution. The present invention discloses a projection screen capable of maintaining a polarization state of projection light. It comprises a plurality of projection screen units, each of which includes at least two layers of optical layered structures, wherein a phase change of each optical layered structure is compensated by other layers.

In one embodiment of present patent application, the material of each layer of optical layered structure is configured to include an optical medium film or a metal film.

In another embodiment of present patent application, each optical layered structure is configured to be a multilayer optical medium film.

In another embodiment of present patent application, each optical layered structure is configured to be a metal film; and reflection angles of the metal films are set to be smaller than 45 degrees.

In another embodiment of present patent application, each layer of optical layered structure is provided with two layers of films, wherein a first layer of film is configured to be a metal film, a second layer of film is configured to be a fully transparent optical medium film, and the fully transparent optical medium film is disposed above the metal film.

In another embodiment of present patent application, each optical layered structure is provided with two layers of metal films.

In another embodiment of present patent application, optical axis directions of the layers of optical layered structures are tilted with respect to the corresponding projection screen unit.

In another embodiment of present patent application, the tilting angles of the optical axis directions of the layers of optical layered structures arranged obliquely with respect to the corresponding projection screen unit are between +/−20 degrees and +/−45 degrees.

In another embodiment of present patent application, the specific angular surface distribution of tilting angles is controlled by means of one or more of laser direct writing, binary optics or diffractive optics, and embossing.

For the application to each technical solution described above, as an example, the nanoimprint method is used to form a specific surface shape on a mold by computer control machining to increase tilting angles. The optical axis directions of the layers of optical layered structures are arranged obliquely with respect to the corresponding projection screen unit.

In above solutions of the present invention, by providing at least two layers of optical layered structures, and by material selection and thickness design of a medium constituting each layer of optical layered structure, the phase compensation can be achieved such that phase and amplitude changes of one layer of optical layered structure can be compensated by the other layer(s) of optical layered structure. The polarization state of emergent light is consistent with the polarization state of incident light. The polarization maintaining ratio may be 200:1 to 2000:1 or more, wherein the most preferred typical polarization maintaining ratio is 1000:1. In this way, ghosting of 3D movies can be greatly eliminated. Dizziness of viwers can be reduced. 3D movie viewing experience is improved.

### BRIEF DESCRIPTION OF THE DRAWINGS

FIG. 1A is a schematic diagram of depolarization of p-linearly polarized light in phase depolarization in the prior art.

FIG. 1B is a schematic diagram of depolarization of s-linearly polarized light in phase depolarization in the prior art.

FIG. 2 is a schematic diagram of amplitude depolarization in the prior art.

FIG. 3 is a schematic diagram of geometric depolarization in the prior art.

FIG. 4 is a structural schematic diagram of an embodiment of a projection screen in the present invention.

FIG. 5 is a structural schematic diagram of another embodiment of a projection screen in the present invention.

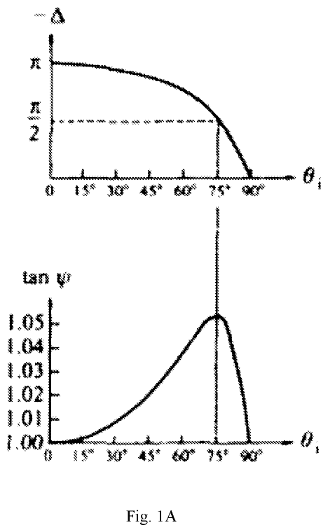

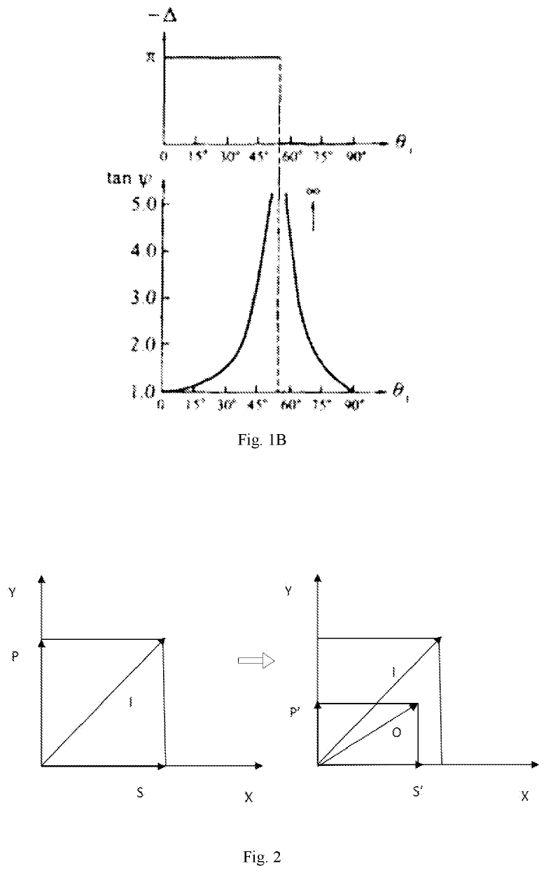

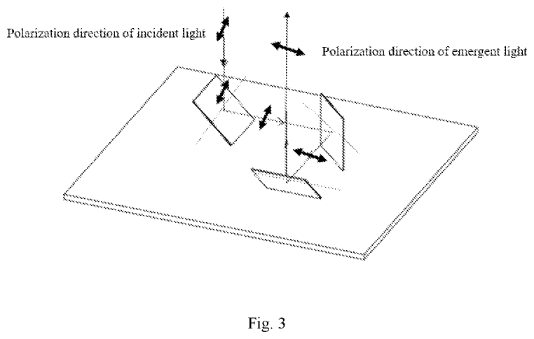

### DETAILED DESCRIPTION

The present invention is described in detail below in conjunction with the drawings and specific embodiments.

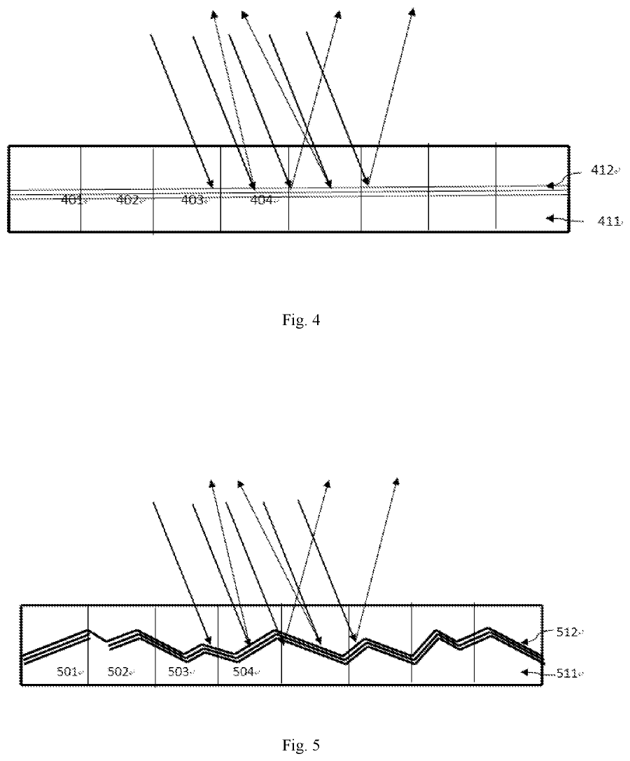

This first embodiment of present invention discloses a projection screen capable of maintaining a polarization state of projection light are shown in FIG. 4. The projection screen comprises a plurality of projection screen units, denoted by a projection screen unit 401, a projection screen unit 402, a projection screen unit 403, a projection screen unit 404, etc.

Furthermore, each said projection screen unit comprise at least two layers of optical layered structures, i.e. each projection screen unit may compprise two layers of optical layered structures, or three layers of optical layered structures, or more layers of optical layered structures. Each of the projection screen units generally comprises the same layers of optical layered structures.

Each layer of optical layered structure is made from optical medium film and/ora metal film. In this way, phase compensation can be achieved by material selection and thickness design of each layer of optical layered structure, such that phase and amplitude changes of reflected light from one layer of optical layered structure can be compensated by the other layer(s) of optical layered structure.

Since each projection screen unit includes at least two layers of optical layered structures, which could be optical medium film with different refractive index or/and metal film, a substantial reflection effect happens. T light from the direction of the projector is reflected back into the eyes of a viewer at certain angular distribution.

For example, in first embodiment of the present invention, each projection screen unit includes at least two layers of optical layered structures that is configured to be a multilayer optical medium film. Because each optical layered structure is configured to be a multilayer optical medium film, the reflected lights have 180 degrees phase change for both p polarized light and s polarized light, therefore the polarization of reflected light does not change when reflection occurs. Furthermore, as the optical layered structure is configured to be a multilayer optical medium film, the multilayer optical medium film is designed to have the same reflectivity for p light and s light during reflection. The reflected light does not change the polarization direction.

For another example, in second embodiment of the present invention, each projection screen unit includes at least two layers of optical layered structures that is configured to be metal film. The reflection angles of the metal films are set to be smaller than 45 degree. In this way, when reflection occurs, phase changes added by the material for polarized light in different directions are substaintial small, therefore the polarization state of the reflected light is not changed. For other example, in a third embodiment of the present invention shown in FIG. 4, wherein each projection screen unit includes at least two layers of optical layered structuresthat comprises a first layer of film 411 and a second layer of film 412. Said first layer of film 411 is configured to be a metal film, and the second layer of film 412 is configured to be a fully transparent optical medium film. The fully transparent optical medium film 412 is disposed above the metal film 411. In this way, the two layers of films achieve two functions: 1) When light is reflected on the fully transparent optical medium film, the phase change of reflection light on the surface of the metal film and a phase change on the transparent medium film cancel with each other to maintain polarization. Therefore the polarization of reflected light is preserved.

Finally, in a fourth embodiment of the present invention, each screen unit comprises at least two layers of optical layered structures. Said optical layered structure comprises two layers of metal films. In this way, phase changes caused by reflection on the two metal surfaces cancel with each other to main polarization. Therefore the polarization state of the reflected light is preserved.

Moreover, in the above embodiments, to ensure a certain angular distribution of the reflected light on the projection screen, the reflection of light by the two or more optical layered structures of each projection screen unit also requires some angular distributions.

These angular distributions may be achieved by diffracting and scattering the light to different angles because said optical layered structures have certain angular distribution. Alternatively, these different angular distributions may also be achived by using different surface contour and optical axes of the projection screen units.

if the different surface contour shapes and optical axes of the projection screen units are used to control the light distribution, the optical axis directions of the layers of optical layered structures are arranged obliquely with respect to the normal direction of corresponding projection screen unit. The inclination angles and distributions of the optical layered structures are designed according to the viewing angle requirement of the projection screen. Generally a inclination angle between +/−20 degrees and +/−45 degrees is required. For example, as shown in FIG. 5, the orientation of first layer of optical layered structure 511 and the second layer of optical layered structure 512 are respectively arranged obliquely with respect to the corresponding projection screen unit.

The inclination angles are controlled by using laser direct writing, binary optics, diffractive optics and surface embossing to achieve and the specific angular surface distribution.

For example, the laser direct writing method can be used to form surfaces with a specific inclinations. The inclination angles of different units are in a certain distribution within a certain angle. Therefore that the light coming from one direction is redirected to different directions. Therfore the image projected by the projector to the screen has a certain distribution at viewing angles. For another example, many small surfaces with a specific inclination are formed on a mold first. Then different projection screen units are formed on a flexible basis by using a nanoimprint mold. The inclination angles of projection screen unit have certain distribution within a certain angle. Therfore the light coming from one direction are redirected into different directions. The image projected by the projector to the screen has a certain distribution of viewing angles.

For another example, the binary optics or diffractive optics method are used to redirect the light to different directions to form a certain distribution of viewing angles. Specific diffraction pattern are manufactured by a mold or optical recording.

For another example, a specific angular surface distribution is manufactured using sandblasting process or a specific corrosion process. The mold is manufactured by a specific sandblasting process, a specific corrosion process, or a friction process. The contour of mold is transferred to plastic substrate to control the view angle of the projection screen.

It is also possible to use a nanoimprint method by which a specific surface shape is formed on a mold by computer control to increase projection angles, wherein specifically

Alternatively, a nanoimprint method may also be used to form a specific surface shape on a mold by computer control to increase the projection angle, so that optical axis directions of the layers of optical layered structures may be arranged obliquely with respect to the corresponding projection screen unit.

The inclination angles and the spatial distribution of each projection screen unit ensure a minimum geometric depolarization effect for most light, thereby the polasrization of reflected light is preserved. polarization.

Using above embodiment of the present invention, the polarization state of reflected light is preserved with the polarization state of incident light. The polarization maintaining ratio is between 200:1 to 2000:1 or more. A typical polarization maintaining ratio is about 1000:1. In this way, the ghosting image of 3D movies can be greatly eliminated. Dizziness of viewer is reduced and 3D movie viewing experience is improved.

Described above are only preferred embodiments of the present invention, which are not intended to limit the present invention. All modifications, equivalent substitutions and improvements made within the spirit and principle of the present invention should be included within the protection scope of the present invention.

1. A projection screen maintaining the polarization state of projection light redirected from the screen, comprising a plurality of projection screen units, the projection screen unit further comprises at least two layers of optical layered structures, wherein the phase change of the first optical layered structure is compensated by the second optical layered structure.

2. The projection screen maintaining the polarization state of the projection light redirected from the screen according to claim 1, wherein each layer of optical layered structure is made from optical medium film and/or metal film.

3. The projection screen maintaining the polarization state of the projection light redirected from the screen according to claim 2, wherein each layer of optical layered structure is made from multilayer optical films.

4. The projection screen maintaining the polarization state of the projection light redirected from the screen according to claim 2, wherein each optical layered structure is made from metal film and reflection angles of the metal films are set to be smaller than 45 degrees.

5. The projection screen maintaining the polarization state of the projection light redirected from the screen according to claim 2, wherein each layer of optical layered structure comprises two layers of films; the first layer of film is made from metal, the second layer of film is made from a transparent optical medium film, and the optical medium film is disposed above the metal film.

6. The projection screen maintaining the polarization state of the projection light redirected from the screen according to claim 2, wherein each optical layered structure comprises two layers of different metal films.

7. The projection screen capable of maintaining the polarization state of the projection light according to claim 6, wherein optical axis directions of the layers of optical layered structures are tilted with respect to the normal axis of corresponding projection screen unit.

8. The projection screen maintaining the polarization state of the projection light according to claim 7, wherein the tilting angles of the optical axis directions of the layers of optical layered structures are between +/−20 degrees and +/−45 degrees with respect to the axis of corresponding projection screen unit.

9. The projection screen maintaining the polarization state of the projection light according to claim 8, wherein the tilting angles are controlled to a specific angular distribution by one or more of following methods: laser direct writing, binary optics, diffractive optics, and surface embossing.

10. The projection screen maintaining the polarization state of the projection light according to claim 7, wherein the nanoimprint method is used to form a specific surface shape on a mold by computer control machining to increase tilting angles, wherein the optical axis directions of the layers of optical layered structures are arranged obliquely with respect to the corresponding projection screen unit.

11. The projection screen capable of maintaining the polarization state of the projection light according to claim 4, wherein optical axis directions of the layers of optical layered structures are tilted with respect to the normal axis of corresponding projection screen unit.

12. The projection screen maintaining the polarization state of the projection light according to claim 11, wherein the tilting angles of the optical axis directions of the layers of optical layered structures are between +/−20 degrees and +/−45 degrees with respect to the axis of corresponding projection screen unit.

13. The projection screen maintaining the polarization state of the projection light according to claim 12, wherein the tilting angles are controlled to a specific angular distribution by one or more of following methods: laser direct writing, binary optics, diffractive optics, and surface embossing.

14. The projection screen maintaining the polarization state of the projection light according to claim 11, wherein the nanoimprint method is used to form a specific surface shape on a mold by computer control machining to increase tilting angles, wherein the optical axis directions of the layers of optical layered structures are arranged obliquely with respect to the corresponding projection screen unit.

15. The projection screen capable of maintaining the polarization state of the projection light according to claim 3, wherein optical axis directions of the layers of optical layered structures are tilted with respect to the normal axis of corresponding projection screen unit.

16. The projection screen maintaining the polarization state of the projection light according to claim 15, wherein the tilting angles of the optical axis directions of the layers of optical layered structures are between +/−20 degrees and +/−45 degrees with respect to the axis of corresponding projection screen unit.

17. The projection screen capable of maintaining the polarization state of the projection light according to claim 2, wherein optical axis directions of the layers of optical layered structures are tilted with respect to the normal axis of corresponding projection screen unit.

18. The projection screen maintaining the polarization state of the projection light according to claim 17, wherein the tilting angles of the optical axis directions of the layers of optical layered structures are between +/−20 degrees and +/−45 degrees with respect to the axis of corresponding projection screen unit.

19. The projection screen maintaining the polarization state of the projection light according to claim 18, wherein the tilting angles are controlled to a specific angular distribution by one or more of following methods: laser direct writing, binary optics, diffractive optics, and surface embossing.

20. The projection screen maintaining the polarization state of the projection light according to claim 17, wherein the nanoimprint method is used to form a specific surface shape on a mold by computer control machining to increase tilting angles, wherein the optical axis directions of the layers of optical layered structures are arranged obliquely with respect to the corresponding projection screen unit.
